(19) United States
(12) Patent Application Publication
(10) Pub. No.: US 2025/0168914 A1
(43) Pub. Date: May 22, 2025

(54) METHOD AND APPARATUS OF AN ENHANCED MECHANISM FOR AN RRC REESTABLISHMENT PROCEDURE

(71) Applicant: Lenovo (Beijing) Limited, Beijing (CN)

(72) Inventors: Lianhai WU, Beijing (CN); Haiming WANG, Beijing (CN)

(21) Appl. No.: 18/843,043

(22) PCT Filed: May 25, 2022
(86) PCT No.: PCT/CN2022/095056

§ 371 Date: Aug. 30, 2024

(51) Int. Cl. H04W 76/19; H04W 36/30; H04W 36/36

(52) U.S. Cl. CPC H04W 76/19; H04W 36/305; H04W 36/362

(57) ABSTRACT

Embodiments of the present disclosure relate to methods and apparatuses of an enhanced mechanism for a radio resource control (RRC) reestablishment procedure. According to an embodiment of the present application, a user equipment (UE) includes a transceiver and a processor coupled to the transceiver; and the processor is configured to: initiate a radio resource control (RRC) reestablishment procedure; transmit an RRC reestablishment request message via the transceiver to a network node via a relay node; start a timer for RRC reestablishment request in response to transmitting the RRC reestablishment request message; and stop the timer for RRC reestablishment request in response to a pre-specified condition associated with reception of a notification message being met.

### TECHNICAL FIELD

Embodiments of the present disclosure generally relate to wireless communication technology, in particular to methods and apparatuses of an enhanced mechanism for a radio resource control (RRC) reestablishment procedure.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. A relaying function based on a sidelink may be supported in a communication network. For example, a UE supporting sidelink communication may function as a relay node to extend the coverage of a BS. An out-of-coverage or in-coverage UE may communicate with a BS via a relay node (e.g., a relay UE). In the context of the present disclosure, a UE, which functions as a relay between another UE and a BS, may be referred to as a UE-to-network (U2N) relay.

A UE may be in an RRC connected state, an RRC idle state, or an RRC inactive state. An RRC connected state may also be named as “a connected state” or “an RRC_CONNECTED state” or the like. An RRC idle state may also be named as “an idle state” or “an RRC_IDLE state” or the like. An RRC inactive state may also be named as “an inactive state” or “an RRC_INACTIVE state” or the like.

There is a need for efficiently performing communication in a communication system supporting a U2N relay.

### SUMMARY

Some embodiments of the present application provide a user equipment (UE). The UE includes a transceiver and a processor coupled to the transceiver; and the processor is configured to initiate a first radio resource control (RRC) reestablishment procedure; transmit a first RRC reestablishment request message via the transceiver to a network node via a first relay node; start a first timer for RRC reestablishment request in response to transmitting the first RRC reestablishment request message; and stop the first timer for RRC reestablishment request in response to a pre-specified condition associated with reception of a notification message being met.

In some embodiments, wherein the notification message indicates at least one of: a handover of the first relay node, a radio link failure (RLF) between the first relay node and the network node, a cell reselection of the first relay node, or an RRC connection failure of the first relay node including an RRC connection reject, an expiry of the timer for transmission of RRCSetupRequest (e.g., T300), and/or an RRC resume failure.

In some embodiments, the processor of the UE is configured to release configuration information related to a PC5 relay radio link control (RLC) channel, in response to at least one of: initiating the first RRC reestablishment procedure; initiating the first RRC reestablishment procedure and the UE being not configured with a conditional reconfiguration configuration associated with a candidate target cell; or initiating the first RRC reestablishment procedure and the UE being not configured with an indication for indicating that the UE shall perform the conditional reconfiguration configuration if a selected cell is configured with conditional handover (CHO) for the first time after a failure.

In some embodiments, the processor of the UE is configured to perform at least one of a first cell selection operation, a first relay selection operation, or a first relay reselection operation, in response to initiating the first RRC reestablishment procedure.

In some embodiments, the processor of the UE is configured to receive the notification message via the transceiver from the first relay UE.

In some embodiments, the processor of the UE is configured to enter an RRC idle state in response to the pre-specified condition being met or in response to stopping the first timer for RRC reestablishment request.

In some embodiments, the processor of the UE is configured to initiate a second RRC reestablishment procedure in response to the pre-specified condition being met or in response to stopping the first timer for RRC reestablishment request.

In some embodiments, the pre-specified condition includes a cell change upon the reception of the notification message.

In some embodiments, the pre-specified condition includes at least one of: the reception of the notification message from the first relay node; the UE considers that a selected cell becomes unsuitable upon the reception of the notification message; the UE considers that a cell selection operation occurs upon the reception of the notification message; the UE considers the first timer for RRC reestablishment request as expired upon the reception of the notification message.

In some embodiments, the processor of the UE is configured to perform at least one of a second cell selection operation, a second relay selection operation, or a second relay reselection operation after initiating the second RRC reestablishment procedure.

In some embodiments, during the at least one of the second cell selection operation, the second relay selection operation, or the second relay reselection operation: the first relay node is not allowed to be selected in response to: another suitable relay node being available; or a suitable cell being available; and the first relay node is allowed to be selected in response to: the notification message indicating time duration and the time duration having elapsed after the reception of the notification message; or a discovery message received from the first relay node including a cell identifier (ID) different from a first cell ID of the first relay node.

In some embodiments, the processor of the UE is configured to: transmit a second RRC reestablishment request message via the transceiver to the network node; and start a second timer for RRC reestablishment request in response to transmitting the second RRC reestablishment request message.

In some embodiments, the processor of the UE is configured to receive an RRC reestablishment message responding to the first RRC reestablishment request message via the transceiver from the network node.

In some embodiments, the RRC reestablishment message is received before transmitting the second RRC reestablishment request message or after short time duration since transmitting the second RRC reestablishment request message.

In some embodiments, in response to receiving the RRC reestablishment message, the processor of the UE is configured to: discard the RRC reestablishment message; or apply the RRC reestablishment message and stop the second timer for RRC reestablishment request.

Some embodiments of the present application provide a method, which may be performed by a UE. The method includes: initiating a first radio resource control (RRC) reestablishment procedure; transmitting a first RRC reestablishment request message to a network node via a first relay node; starting a first timer for RRC reestablishment request in response to transmitting the first RRC reestablishment request message; and stopping the first timer for RRC reestablishment request in response to a pre-specified condition associated with reception of a notification message being met.

In some embodiments, the notification message indicates at least one of: a handover of the first relay node, a radio link failure (RLF) between the first relay node and the network node, a cell reselection of the first relay node, or an RRC connection failure of the first relay node including an RRC connection reject, an expiry of a timer for transmission of RRCSetupRequest (e.g., T300), and/or an RRC resume failure.

In some embodiments, the method further comprises: releasing configuration information related to a PC5 relay radio link control (RLC) channel, in response to at least one of: initiating the first RRC reestablishment procedure; initiating the first RRC reestablishment procedure and the UE being not configured with a conditional reconfiguration configuration associated with a candidate target cell; or initiating the first RRC reestablishment procedure and the UE being not configured with an indication for indicating that the UE shall perform the conditional reconfiguration configuration if a selected cell is configured with conditional handover (CHO) for the first time after a failure.

In some embodiments, the method further comprises: performing at least one of a first cell selection operation, a first relay selection operation, or a first relay reselection operation, in response to initiating the first RRC reestablishment procedure.

In some embodiments, the method further comprises: receiving the notification message from the first relay UE.

In some embodiments, the method further comprises: entering an RRC idle state in response to the pre-specified condition being met or in response to stopping the first timer for RRC reestablishment request.

In some embodiments, the method further comprises: initiating a second RRC reestablishment procedure in response to the pre-specified condition being met or in response to stopping the first timer for RRC reestablishment request.

In some embodiments, the pre-specified condition includes a cell change upon the reception of the notification message.

In some embodiments, the pre-specified condition includes at least one of: the reception of the notification message from the first relay node; the UE considers that a selected cell becomes unsuitable upon the reception of the notification message; the UE considers that a cell selection operation occurs upon the reception of the notification message; the UE considers the first timer for RRC reestablishment request as expired upon the reception of the notification message.

In some embodiments, the method further comprises: performing at least one of a second cell selection operation, a second relay selection operation, or a second relay reselection operation after initiating the second RRC reestablishment procedure.

In some embodiments, during the at least one of the second cell selection operation, the second relay selection operation, or the second relay reselection operation: the first relay node is not allowed to be selected in response to: another suitable relay node being available; or a suitable cell being available; and the first relay node is allowed to be selected in response to: the notification message indicating time duration and the time duration having elapsed after the reception of the notification message; or a discovery message received from the first relay node including a cell identifier (ID) different from a first cell ID of the first relay node.

In some embodiments, the method further comprises: transmitting a second RRC reestablishment request message to the network node; and starting a second timer for RRC reestablishment request in response to transmitting the second RRC reestablishment request message.

In some embodiments, the method further comprises: receiving an RRC reestablishment message responding to the first RRC reestablishment request message from the network node.

In some embodiments, the RRC reestablishment message is received before transmitting the second RRC reestablishment request message or after short time duration since transmitting the second RRC reestablishment request message.

In some embodiments, in response to receiving the RRC reestablishment message, the method further comprises: discarding the RRC reestablishment message; or applying the RRC reestablishment message and stop the second timer for RRC reestablishment request.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a remote UE or a relay UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure.

FIG. 2 illustrates a schematic diagram of a relay based wireless communication system in accordance with some embodiments of the present disclosure.

FIG. 3 illustrates a flowchart of an exemplary procedure for reestablishing an RRC connection in accordance with some embodiments of the present disclosure.

FIG. 4 illustrates an exemplary flowchart for initiating an RRC reestablishment procedure in accordance with some embodiments of the present disclosure.

FIG. 5 illustrates an exemplary flowchart of an RRC reestablishment procedure in accordance with some embodiments of the present disclosure.

FIG. 6 illustrates a further exemplary flowchart of an RRC reestablishment procedure in accordance with some embodiments of the present disclosure.

FIG. 7 illustrates an exemplary block diagram of an apparatus for an RRC reestablishment procedure in accordance with some embodiments of the present disclosure.

FIG. 8 illustrates a further exemplary block diagram of an apparatus for an RRC reestablishment procedure in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

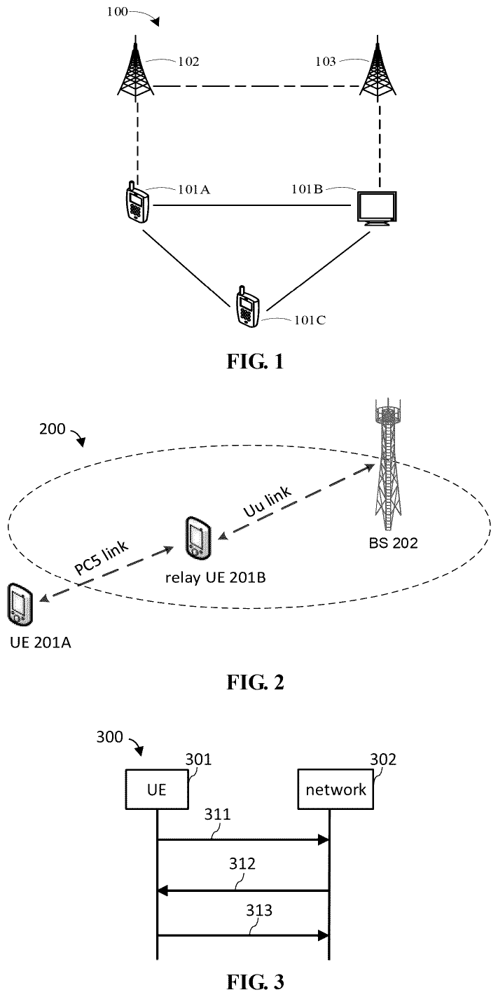

FIG. 1 illustrates a schematic diagram of a wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X sidelink communication.

NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, the wireless communication system 100 may include some base stations (e.g., BS 102 and BS 103) and some UEs (e.g., UE 101A, UE 101B, and UE 101C). Although a specific number of UEs and BSs are depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, BS 102 and BS 103 may be included in a next generation radio access network (NG-RAN). In some embodiments of the present disclosure, BS 102 may be a gNB and BS 103 may be an ng-eNB.

UE 101A and UE 101B may be in-coverage (e.g., inside the NG-RAN). For example, as shown in FIG. 1, UE 101A may be within the coverage of BS 102, and UE 101B may be within the coverage of BS 103. UE 101C may be out-of-coverage (e.g., outside the coverage of the NG-RAN). For example, as shown in FIG. 1, UE 101C may be outside the coverage of any BS, for example, both BS 102 and BS 103. UE 101A and UE 101B may respectively connect to BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. BS 102 and BS 103 may be connected to each other via a network interface, for example, the Xn interface as specified in 3GPP standard documents. UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, UE 101A, which is within the coverage of BS 102, can perform sidelink transmission and reception (e.g., sidelink unicast transmission, sidelink groupcast transmission, or sidelink broadcast transmission) over a PC5 interface. UE 101C, which is outside the coverage of both BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. In some embodiments of the present disclosure, a UE-to-network relay is supported. For example, an in-coverage UE in communication with a remote UE (e.g., an out-of-coverage UE or in-coverage UE) may function as a relay UE between the serving BS of the in-coverage UE and the remote UE. The remote UE may thus communicate with the BS via this relay UE. The data between the remote UE and the BS may be transferred by the relay UE. In this scenario, the relay UE may be referred to as a serving relay of the remote UE, and the serving BS or serving cell of the relay UE may be referred to as the serving BS or serving cell of the remote UE.

FIG. 2 illustrates a schematic diagram of a relay based wireless communication system 200 in accordance with some embodiments of the present disclosure. Details described in all of the foregoing embodiments of the present disclosure are applicable for the embodiments shown in FIG. 2.

As shown in FIG. 2, the wireless communication system 200 may include a BS (e.g., BS 202) and some UEs (e.g., UE 201A and UE 201B). Although a specific number of UEs and BS is depicted in FIG. 2, it is contemplated that any number of UEs and BSs may be included in the wireless communication system 200. In some examples, UE 201B may function as UE 101A or UE 101B shown in FIG. 1, and UE 201A may function as UE 101C shown in FIG. 1.

UE 201B may be within the coverage of BS 202. For example, UE 201B and BS 202 may establish an RRC connection therebetween. UE 201A may be outside of the coverage of BS 202. The wireless communication system 200 may support sidelink communications. For example, UE 201B may be in sidelink communication with UE 201A. A PC5 RRC connection may be established between UE 201A and UE 201B.

In some embodiments of the present disclosure, UE 201A may initiate a procedure for establishing a connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. This cell may be referred to as a serving cell of UE 201A. UE 201A and BS 202 may establish an RRC connection therebetween. UE 201A may have RRC states, such as an RRC_IDLE state, an RRC_INACTIVE state, and an RRC_CONNECTED state. UE 201A may also be referred to as a remote UE and UE 201B may also be referred to as a relay UE or a serving relay of UE 201A.

It should be appreciated by persons skilled in the art that although a single relay node (e.g., UE 201B) between UE 201A and BS 202 is depicted in FIG. 2, it is contemplated that any number of relay nodes may be included. Although it is shown in FIG. 2 that UE 201A is outside of the coverage of BS 202, it is contemplated that UE 201A may be within the coverage of BS 202 in some other embodiments of the present disclosure. In these embodiments, UE 201A may directly connect to BS 202 and/or connect to BS 202 via UE 201B.

A UE (e.g., UE 201A or UE 201B in FIG. 1) may be in one of the following states: RRC_IDLE state, RRC_CONNECTED state, and RRC_INACTIVE state, at a given time. In an RRC_INACTIVE state (hereinafter, “an inactive state”), a UE does not have an RRC connection with the radio access network (RAN), for example, BS 202. However, the RAN keeps a connection with the core network for the UE. Therefore, an RRC_INACTIVE state may achieve power saving with acceptable access latency. The specific characteristics of an RRC_IDLE state, RRC_CONNECTED state, and RRC_INACTIVE state are defined in 3GPP specifications.

FIG. 3 illustrates a flowchart of exemplary procedure 300 for reestablishing an RRC connection in accordance with some embodiments of the present disclosure. Details described in all of the foregoing embodiments of the present disclosure are applicable for the embodiments shown in FIG. 3.

The purpose of exemplary procedure 300 is to reestablish an RRC connection. In response to the initiation of the procedure, UE 301 may start a timer for initiating RRC reestablishment (e.g., T311 as specified in 3GPP specifications) and perform cell or relay selection. In response to selecting a suitable relay node (e.g., an L2 U2N relay UE), UE 301 (e.g., remote UE) may stop the timer for initiating RRC reestablishment. UE 301 may transmit an RRC reestablishment request message to network 302 (e.g., a BS or a cell) in operation 311. UE 301 may start a timer for RRC reestablishment request (e.g., T301 as specified in 3GPP specifications) in response to transmitting the RRC reestablishment request message.

In response to the RRC reestablishment request message, network 302 may transmit an RRC reestablishment message to UE 301 in operation 312. In response to receiving the RRC reestablishment message, UE 301 may stop the timer for RRC reestablishment request. UE 301 may apply configurations according to the RRC reestablishment message and may transmit an RRC reestablishment complete message to network 302 in operation 313.

Embodiments of the present application aim to solve issues during an RRC reestablishment procedure in a network supporting a U2N relay case. For example, some embodiments of the present application study an enhanced mechanism for an RRC reestablishment procedure in a U2N relay case. In some embodiments of the present application, a remote UE is allowed to transmit an RRC reestablishment request message again after the remote UE stops timer T301 due to reception of a notification message. Some embodiments of the present application study principle(s) which a cell selection operation and/or a relay (re-) selection operation may follow. Some embodiments of the present application aim to solve a potential mismatch issue between a remote UE and the serving cell. Some embodiments of the present application introduce stop condition(s) for timer T301 in specific relay case(s).

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

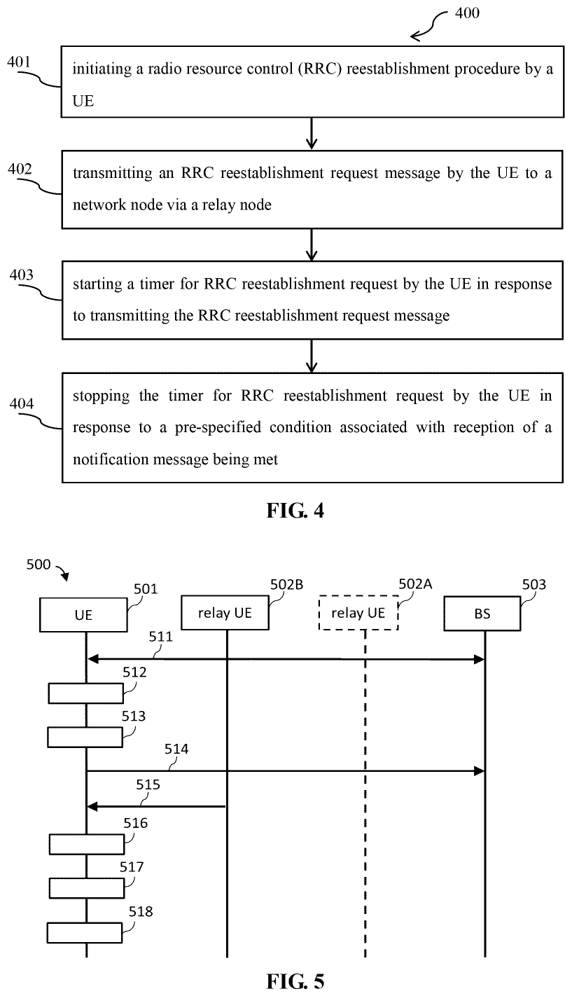

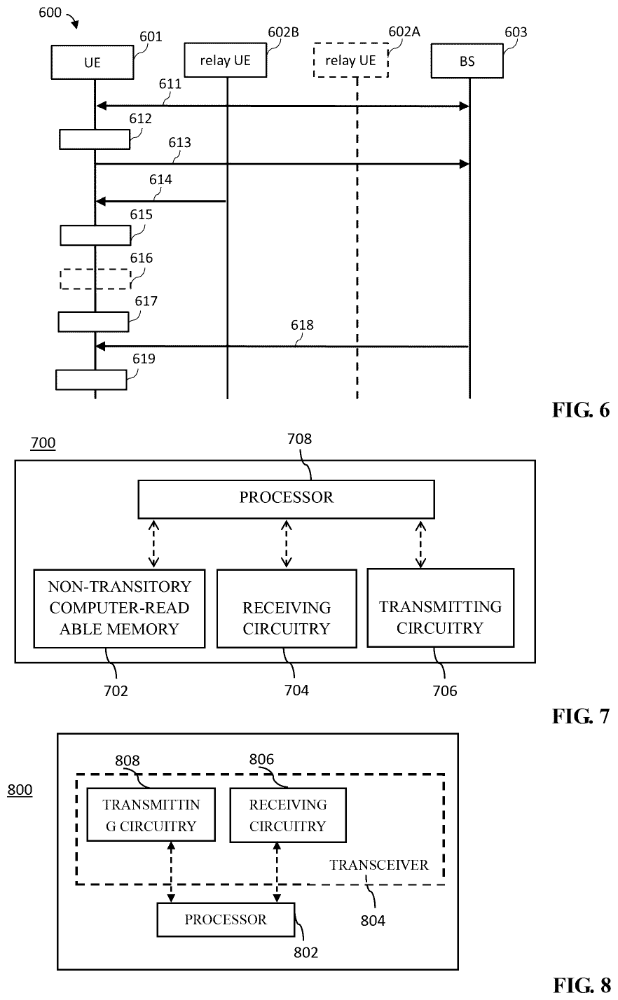

FIG. 4 illustrates an exemplary flowchart 400 for initiating an RRC reestablishment procedure in accordance with some embodiments of the present disclosure. The exemplary flowchart 400 may be performed by a UE (e.g., a remote UE). Specific examples of exemplary flowchart 400 are described in embodiments of FIGS. 5 and 6 as follows. Although described with respect to a UE, it should be understood that other devices may be configured to perform a method similar to that of FIG. 4.

Referring to FIG. 4, in operation 401, a UE (e.g., UE 201A, UE 301, UE 501, or UE 601 as shown in any of FIGS. 2, 3, 5, and 6) may initiate an RRC reestablishment procedure.

In operation 402, the UE may transmit an RRC reestablishment request message to a network node (e.g., BS 202, network 302, BS 503, or BS 603 as shown in any of FIGS. 2, 3, 5, and 6) via a relay node (e.g., relay UE 201B, relay UE 502B, or relay UE 602B as shown in any of FIGS. 2, 5, and 6). The RRC reestablishment request message may be denoted as “first RRC reestablishment request message” for simplicity. The relay node may be denoted as “first relay UE” for simplicity. In some embodiments, before initiating the RRC reestablishment procedure, the UE may access a serving cell of the network node via a direct path or via another relay node (e.g., relay UE 502A or relay UE 602A as shown in FIG. 5 or FIG. 6).

In operation 403, the UE may start a timer for RRC reestablishment request (e.g., T301 as specified in 3GPP specifications) in response to transmitting the RRC reestablishment request message.

In operation 404, the UE may stop the timer for RRC reestablishment request in response to a pre-specified condition associated with reception of a notification message being met.

In some embodiments, the UE may receive the notification message from the relay UE. In some embodiments, the notification message indicates at least one of: a handover of the first relay node, a radio link failure (RLF) between the first relay node and the network node, a cell reselection of the first relay node, or an RRC connection failure of the first relay node. For instance, the RRC connection failure of the first relay node may include an RRC connection reject, an expiry of the timer for transmission of RRCSetupRequest (e.g., T300), and/or an RRC resume failure.

In some embodiments, the UE may release configuration information related to a PC5 RLC channel, in response to initiating the RRC reestablishment procedure. For instance, a PC5 relay RLC channel is an RLC channel between a L2 U2N remote UE and a L2 U2N relay UE, which is used to transport packets over a PC5 link for L2 U2N relay. In an embodiment, the configuration information related to the PC5 relay RLC channel may be released in response to at least one of:
(1) initiating the RRC reestablishment procedure and the UE being not configured with a conditional reconfiguration configuration associated with a candidate target cell (e.g., conditional Reconfiguration information element (IE)).
(2) initiating the RRC reestablishment procedure and the UE being not configured with an indication for indicating that the UE shall perform the conditional reconfiguration configuration associated with a candidate target cell if a selected cell is configured with CHO for the first time after a failure (e.g., attemptCondReconfig IE).

In some embodiments, the UE may perform at least one of a cell selection operation, a relay selection operation, or a relay reselection operation, in response to initiating the RRC reestablishment procedure. For instance, the first relay node (e.g., relay UE 502B or relay UE 602B as shown in FIG. 5 or FIG. 6) may be selected by the UE by performing at least one of the cell selection operation, the relay selection operation, or the relay reselection operation.

In some embodiments, the UE may enter an RRC idle state in response to the pre-specified condition being met or in response to stopping the timer for RRC reestablishment request. A specific example is described in the embodiments of FIG. 5 as follows.

In some embodiments, the UE may initiate another RRC reestablishment procedure (denoted as “second RRC reestablishment procedure” for simplicity) in response to the pre-specified condition being met or in response to stopping the timer for RRC reestablishment request. A specific example is described in the embodiments of FIG. 6 as follows.

In some embodiments, the pre-specified condition includes a cell change upon the reception of the notification message.

In some embodiments, the pre-specified condition includes at least one of: the reception of the notification message from the first relay node; the UE considers that a selected cell becomes unsuitable upon the reception of the notification message; the UE considers that a cell selection operation occurs upon the reception of the notification message; the UE considers the timer for RRC reestablishment request as expired upon the reception of the notification message.

In some embodiments, the UE may perform at least one of another cell selection operation, another relay selection operation, or another relay reselection operation after initiating the second RRC reestablishment procedure. In an embodiment, during at least one of these operations, the first relay node is not allowed to be selected “in response to another suitable relay node being available” or “in response to a suitable cell being available”. In an embodiment, during at least one of these operations, the first relay node is allowed to be selected “in response to the notification message indicating time duration and the time duration having elapsed after the reception of the notification message” or “in response to a discovery message received from the first relay node including a cell identifier (ID) different from a cell ID of the first relay node”. Specific examples are described in the embodiments of FIGS. 5 and 6 as follows.

In some embodiments, the UE may transmit another RRC reestablishment request message (denoted as “second RRC reestablishment request message” for simplicity) to the network node, and start another timer for RRC reestablishment request in response to transmitting the second RRC reestablishment request message.

In some embodiments, the UE may receive an RRC reestablishment message responding to the first RRC reestablishment request message from the network node. In an embodiment, the RRC reestablishment message may be received before transmitting the second RRC reestablishment request message. In a further embodiment, the RRC reestablishment message may be received after short time duration since transmitting the second RRC reestablishment request message.

In some embodiments, in response to receiving the RRC reestablishment message, the UE may discard the RRC reestablishment message, or the UE may apply the RRC reestablishment message and stop the abovementioned another timer for RRC reestablishment request. A specific example is described in the embodiments of FIG. 6 as follows.

It should be appreciated by persons skilled in the art that the sequence of the operations in exemplary procedure 400 may be changed and some of the operations in exemplary procedure 400 may be eliminated or modified, without departing from the spirit and scope of the disclosure. Details described in all other embodiments of the present application (for example, all details regarding an enhanced mechanism for an RRC reestablishment procedure) are applicable for the exemplary flowchart 400. Moreover, details described in the exemplary flowchart 400 are applicable for all the embodiments of FIGS. 5-8.

FIG. 5 illustrates an exemplary flowchart 500 of an RRC reestablishment procedure in accordance with some embodiments of the present disclosure. Details described in all of the foregoing embodiments of the present disclosure are applicable for the embodiments shown in FIG. 5.

Referring to FIG. 5, in operation 511, UE 501 (e.g., a remote UE or a L2 U2N remote UE) accesses BS 503 via a direct path or via a L2 U2N relay UE (e.g., relay UE 502A as shown in FIG. 5, which is labeled as optional). In some embodiments, BS 503 may transmit an indication whether a L2 relay node is supported or not to UE 501.

In operation 512, UE 501 may initiate an RRC reestablishment procedure based on at least one of following conditions:
(1) upon detecting an RLF on a master cell group (MCG) link.
(2) upon detecting an RLF on a sidelink;
(3) upon reception of a notification message (e.g., NotificationMessageSidelink message) including an indication type (e.g., IndicationType IE) by UE 501 in an RRC_CONNECTED state; or
(4) upon a PC5 unicast link release indicated by an upper layer at UE 501 in an RRC_CONNECTED state.

In some embodiments, UE 501 may release PC5 Relay RLC channel(s) if UE 501 is not configured with a conditional reconfiguration configuration associated with a candidate target cell and/or an execution condition associated with the candidate target cell (e.g., conditional Reconfiguration IE), or if UE 501 is not configured with an indication for indicating that the UE shall perform the conditional reconfiguration configuration associated with the candidate target cell if a selected cell is configured with CHO for the first time after a failure (e.g., attemptCondReconfig IE).

In some embodiments, UE 501 may be configured with conditional reconfiguration configuration(s) of candidate target SpCell(s) and/or associated execution condition(s) for a conditional handover, a conditional PSCell addition, or a conditional PSCell change.

In some embodiments, UE 501 may be configured with attemptCondReconfig IE, and this IE is used to indicate that UE 501 shall perform the conditional reconfiguration configuration and/or the associated execution condition(s) if the selected cell is a target candidate cell configured with conditional handover (CHO) for the first time after a failure (e.g., a handover failure).

In operation 513, UE 501 performs a cell selection, a relay selection and/or a relay reselection. Some embodiments assume that one suitable relay UE is selected, e.g., relay UE 502B as shown in FIG. 5.

In operation 514, UE 501 transmits an RRC reestablishment request message to the serving cell of BS 503 via relay UE 502B if one relay UE is selected and starts the timer for RRC reestablishment request (e.g., T301).

In operation 515, UE 501 may receive a notification message from relay UE 502B when at least one of the following conditions is met in relay UE 502B while the timer for RRC reestablishment request (e.g., T301) is running.
(1) upon a Uu RLF in relay UE 502B;
(2) upon reception of an RRCReconfiguration including the reconfigurationWithSync;
(3) upon a cell reselection of relay UE 502B; or
(4) upon an RRC connection failure of relay UE 502B. For example, the RRC connection failure may include an RRC connection reject, an expiry of T300, and/or an RRC resume failure.

In some embodiments, the notification message may include an indication type (e.g., IndicationType IE), for example, which includes a handover of relay UE 502B, an RLF between relay UE 502B and BS 503, a cell reselection of relay UE 502B, and/or an RRC connection failure of relay UE 502B.

Upon the reception of the notification message, UE 501 may consider that at least one of following events occurs.
(1) UE 501 considers “the selected cell becomes unsuitable” upon the reception of the notification message.
(2) UE 501 considers that a cell selection occurs upon the reception of the notification message.
(3) UE 501 considers the timer for RRC reestablishment request (e.g., T301) as expired upon the reception of the notification message.

In operation 516, UE 501 may stop the timer for RRC reestablishment request (e.g., T301) if it is running, when at least one of following conditions (i.e., pre-specified conditions associated with reception of a notification message) is met.
(1) The reception of the notification message.
(2) UE 501 considers “the selected cell becomes unsuitable” upon the reception of the notification message.
(3) UE 501 considers that a cell selection occurs upon the reception of the notification message.
(4) UE 501 considers the timer for RRC reestablishment request (e.g., T301) as expired upon the reception of the notification message.

In operation 517, UE 501 enters an RRC idle state after stopping the timer for RRC reestablishment request (e.g., T301).

In operation 518, after UE 501 enters the RRC idle state, UE 501 may initiate a connection establishment procedure. For instance, before initiating the connection establishment procedure, UE 501 may further perform a cell selection, a cell reselection, a relay selection, and/or a relay reselection. During the cell selection, the cell reselection, the relay selection, and/or the relay reselection, UE 501 may select a relay node. Regarding whether the previous relay node (i.e., relay UE 502B) can be selected again, there may be following different embodiments. For example, in operation 518, the cell (re-) selection and relay (re-) selection may follow the principles.
(1) In some embodiments, when UE 501 performs the cell (re-) selection and/or the relay (re-) reselection, the previous relay node (i.e., relay UE 502B) will not be selected if multiple suitable nodes (including suitable relay node(s) and/or suitable cell(s)) are available.
(2) In some embodiments, time duration could be indicated in the notification message transmitted from relay UE 502B to UE 501. The previous relay node (i.e., relay UE 502B) is allowed to be selected again for an RRC reestablishment purpose after the time duration elapses since receiving the notification message from relay UE 502B.
(3) In some embodiments, if a new cell ID is included in a discovery message sent by the previous relay node (i.e., relay UE 502B), the previous relay UE is allowed to be selected.

In some embodiments, after completing the connection establishment procedure, UE 501 may transmit an RRC setup request message to BS 503. In some embodiments, BS 503 may transmit an RRC setup message to UE 501. Then, UE 501 may enter an RRC connected state after receiving the RRC setup message from BS 503.

It should be appreciated by persons skilled in the art that the sequence of the operations in exemplary procedure 500 may be changed and that some of the operations in exemplary procedure 500 may be eliminated or modified, without departing from the spirit and scope of the disclosure.

FIG. 6 illustrates a further exemplary flowchart 600 of an RRC reestablishment procedure in accordance with some embodiments of the present disclosure. Details described in all of the foregoing embodiments of the present disclosure are applicable for the embodiments shown in FIG. 6.

Referring to FIG. 6, in operation 611, UE 601 (e.g., a remote UE or a L2 U2N remote UE) accesses BS 603 via a direct path or via a L2 U2N relay UE (e.g., relay UE 602A as shown in FIG. 6, which is labeled as optional). In some embodiments, BS 603 may transmit an indication whether a L2 relay node is supported or not to UE 601.

In operation 612, UE 601 may initiate an RRC reestablishment procedure based on at least one of following conditions:
(1) upon detecting an RLF on a MCG link;
(2) upon detecting an RLF on a sidelink;
(3) upon reception of a notification message (e.g., NotificationMessageSidelink message) including an indication type (e.g., IndicationType IE) by UE 601 in an RRC_CONNECTED state; or
(4) upon a PC5 unicast link release indicated by an upper layer at UE 601 in an RRC_CONNECTED state.

In operation 613, UE 601 transmits an RRC reestablishment request message to the serving cell of BS 603 via a relay UE (e.g., relay UE 602B as shown in FIG. 6) and starts a timer for RRC reestablishment request (e.g., T301). Some embodiments assume that one suitable relay UE (i.e., relay UE 602B) is selected in the RRC reestablishment procedure.

In operation 614, UE 601 may receive a notification message from relay UE 602B when at least one of the following conditions is met in relay UE 602B while the timer for RRC reestablishment request (e.g., T301) is running.
(1) upon a Uu RLF in relay UE 602B;
(2) upon reception of an RRCReconfiguration including the reconfigurationWithSync;
(3) upon a cell reselection of relay UE 602B;
(4) upon a RRC connection failure of relay UE 602B. For example, the RRC connection failure may include an RRC connection reject, an expiry of T300, and/or an RRC resume failure.

In some embodiments, the notification message includes an indication type (e.g., IndicationType IE), for example, which includes a handover of relay UE 602B, an RLF between relay UE 602B and BS 603, a cell reselection of relay UE 602B, and/or an RRC connection failure of relay UE 602B.

Upon the reception of the notification message from relay UE 602B, UE 601 may consider that at least one of following events occurs.
(1) UE 601 considers “the selected cell becomes unsuitable” upon the reception of the notification message.
(2) UE 601 considers that a cell selection occurs upon the reception of the notification message.
(3) UE 601 considers the timer for RRC reestablishment request (e.g., T301) as expired upon the reception of the notification message.

In operation 615, UE 601 may stop the timer for RRC reestablishment request (e.g., T301) if it is running, when at least one of following conditions (i.e., pre-specified conditions associated with reception of a notification message) is met.
(1) The reception of the notification message.
(2) A cell change upon the reception of the notification message.
(3) UE 601 considers “the selected cell becomes unsuitable” upon the reception of the notification message.
(4) UE 601 considers that a cell selection occurs upon the reception of the notification message.
(5) UE 601 considers the timer for RRC reestablishment request (e.g., T301) as expired upon the reception of the notification message.

After UE 601 stops the timer for RRC reestablishment request (e.g., T301) in operation 615, in some embodiments, UE 601 may initiate an RRC reestablishment procedure in operation 616, while in some other embodiments, UE 601 may not initiate an RRC reestablishment procedure. That is, operation 616 is optional in the exemplary flowchart 600.

In operation 617, UE 601 may further perform a cell selection, a relay selection, and a relay reselection for an RRC reestablishment purpose, and start the timer for relay or cell selection (e.g., T311). Once a suitable cell or a suitable relay node is selected, UE 601 may transmit another RRC reestablishment request message via the suitable relay node and start another timer for RRC reestablishment request (e.g., T301). Regarding whether the previous relay node (i.e., relay UE 602B) can be selected again in operation 617, there may be following different embodiments. For example, in operation 617, the cell (re-) selection and relay (re-) selection may follow the principles.
(1) In some embodiments, when UE 601 performs the cell (re-) selection, the relay selection, and/or the relay reselection, the previous relay node (i.e., relay UE 602B) will not be selected if multiple suitable nodes (including suitable relay node(s) and/or suitable cell(s)) are available.
(2) In some embodiments, time duration could be indicated in the notification message transmitted from relay UE 602B to UE 601. The previous relay node (i.e., relay UE 602B) is allowed to be selected again for an RRC reestablishment purpose after the time duration elapses since receiving the notification message from relay UE 602B.
(3) In some embodiments, if a new cell ID is included in a discovery message sent by the previous relay node (i.e., relay UE 602B), the previous relay UE is allowed to be selected.

In operation 618, UE 601 may receive “an RRC reestablishment message responding to the RRC reestablishment request message in operation 613” from BS 603. In some embodiments, before transmitting the abovementioned another RRC reestablishment request message in operation 617, UE 601 receives the RRC reestablishment message responding to the RRC reestablishment request message in operation 613. In some other embodiments, after the very short elapsed time since UE 601 transmitting the abovementioned another reestablishment request message in operation 617, UE 601 receives the RRC reestablishment message responding to the RRC reestablishment request message in operation 613.

In operation 619, UE 601 may adopt operations in different embodiments. In some embodiments, UE 601 may discard the RRC reestablishment message received in operation 618. In some other embodiments, UE 601 may apply the RRC reestablishment message received in operation 618 and stop the abovementioned timer for RRC reestablishment request (e.g., T301) in operation 617.

It should be appreciated by persons skilled in the art that the sequence of the operations in exemplary procedure 600 may be changed and that some of the operations in exemplary procedure 600 may be eliminated or modified, without departing from the spirit and scope of the disclosure.

FIG. 7 illustrates an exemplary block diagram of an apparatus 700 for an RRC reestablishment procedure in accordance with some embodiments of the present disclosure.

As shown in FIG. 7, the apparatus 700 may include at least one non-transitory computer-readable medium 702, at least one receiving circuitry 701, at least one transmitting circuitry 706, and at least one processor 708 coupled to the non-transitory computer-readable medium 702, the receiving circuitry 704 and the transmitting circuitry 706. The at least one processor 708 may be a CPU, a DSP, a microprocessor etc. The apparatus 700 may be a network apparatus (e.g., a BS) or a UE (e.g., a remote UE or a relay UE) configured to perform the methods illustrated in the above or the like.

Although in this figure, elements such as the at least one processor 708, receiving circuitry 704, and transmitting circuitry 706 are described in the singular, the plural is contemplated unless a limitation to the singular is explicitly stated. In some embodiments of the present application, the receiving circuitry 704 and the transmitting circuitry 706 can be combined into a single device, such as a transceiver. In certain embodiments of the present application, the apparatus 700 may further include an input device, a memory, and/or other components.

In some embodiments of the present application, the non-transitory computer-readable medium 702 may have stored thereon computer-executable instructions to cause a processor to implement the method with respect to a remote UE as described above. For example, the computer-executable instructions, when executed, cause the processor 708 interacting with receiving circuitry 704 and transmitting circuitry 706, so as to perform the steps with respect to a remote UE as illustrated above.

In some embodiments of the present application, the non-transitory computer-readable medium 702 may have stored thereon computer-executable instructions to cause a processor to implement the method with respect to a relay UE as described above. For example, the computer-executable instructions, when executed, cause the processor 708 interacting with receiving circuitry 704 and transmitting circuitry 706, so as to perform the steps with respect to a relay UE as illustrated above.

FIG. 8 illustrates a further exemplary block diagram of an apparatus 800 for an RRC reestablishment procedure in accordance with some embodiments of the present disclosure.

Referring to FIG. 8, the apparatus 800, for example a BS or a UE, may include at least one processor 802 and at least one transceiver 804 coupled to the at least one processor 802. The transceiver 804 may include at least one separate receiving circuitry 806 and transmitting circuitry 808, or at least one integrated receiving circuitry 806 and transmitting circuitry 808. The at least one processor 802 may be a CPU, a DSP, a microprocessor etc.

According to some other embodiments of the present application, when the apparatus 800 is a remote UE, the processor 802 may be configured to initiate a radio resource control (RRC) reestablishment procedure; transmit an RRC reestablishment request message via the transceiver 804 to a network node via a relay node; start a timer for RRC reestablishment request in response to transmitting the RRC reestablishment request message; and stop the timer for RRC reestablishment request in response to a pre-specified condition associated with reception of a notification message being met.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover” and “path switch” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and is configured to cause the UE to:
initiate a first radio resource control (RRC) reestablishment procedure;
transmit a first RRC reestablishment request message via the transceiver to a network node via a first relay node;
start a first timer for RRC reestablishment request in response to transmitting the first RRC reestablishment request message; and
stop the first timer for RRC reestablishment request in response to a pre-specified condition associated with reception of a notification message being met.

2. The UE of claim 1, wherein the notification message indicates at least one of: a handover of the first relay node, a radio link failure (RLF) between the first relay node and the network node, a cell reselection of the first relay node, or an RRC connection failure of the first relay node.

3. The UE of claim 1, wherein the at least one processor is configured to cause the UE to: release configuration information related to a PC5 relay radio link control (RLC) channel, in response to at least one of:
initiating the first RRC reestablishment procedure;
initiating the first RRC reestablishment procedure and the UE not being configured with a conditional reconfiguration configuration associated with a candidate target cell; or
initiating the first RRC reestablishment procedure and the UE not being not configured with an indication for indicating that the UE is to perform the conditional reconfiguration configuration if a selected cell is configured with conditional handover (CHO) for the first time after a failure.

4. The UE of claim 1, wherein the at least one processor is further configured to cause the UE to: perform at least one of: a first cell selection operation, a first relay selection operation, or a first relay reselection operation, in response to initiating the first RRC reestablishment procedure.

5. The UE of claim 1, wherein the at least one processor is further configured to cause the UE to: receive the notification message from the first relay UE.

6. The UE of claim 1, wherein the at least one processor is further configured to cause the UE to: enter an RRC idle state in response to the pre-specified condition being met or in response to stopping the first timer for RRC reestablishment request.

7. The UE of claim 1, wherein the at least one processor is further configured to cause the UE to: initiate a second RRC reestablishment procedure in response to the pre-specified condition being met or in response to stopping the first timer for RRC reestablishment request.

8. The UE of claim 7, wherein the pre-specified condition includes a cell change upon the reception of the notification message.

9. The UE claim 1, wherein the pre-specified condition includes at least one of:
the reception of the notification message from the first relay node;
the UE considers that a selected cell becomes unsuitable upon the reception of the notification message;
the UE considers that a cell selection operation occurs upon the reception of the notification message; or
the UE considers the first timer for RRC reestablishment request as expired upon the reception of the notification message.

10. The UE of claim 7, wherein the at least one processor is further configured to cause the UE to: perform at least one of a second cell selection operation, a second relay selection operation, or a second relay reselection operation after initiating the second RRC reestablishment procedure.

11. The UE of claim 10, wherein, during the at least one of the second cell selection operation, the second relay selection operation, or the second relay reselection operation:
the first relay node is not allowed to be selected in response to:
another suitable relay node being available; or
a suitable cell being available; and
the first relay node is allowed to be selected in response to:
the notification message indicating time duration and the time duration having elapsed after the reception of the notification message; or
a discovery message received from the first relay node including a cell identifier (ID) different from a first cell ID of the first relay node.

12. The UE of claim 7, wherein the at least one processor is further configured to cause the UE to:
transmit a second RRC reestablishment request message via the transceiver to the network node; and
start a second timer for RRC reestablishment request in response to transmitting the second RRC reestablishment request message.

13. The UE of claim 7, wherein the at least one processor is further configured to cause the UE to: receive an RRC reestablishment message responding to the first RRC reestablishment request message via the transceiver from the network node.

14. The UE of claim 13, wherein, in response to receiving the RRC reestablishment message, the at least one processor is further configured to cause the UE to:
discard the RRC reestablishment message; or
apply the RRC reestablishment message and stop the second timer for RRC reestablishment request.

15. A method performed by a user equipment (UE), the method comprising:
initiating a first radio resource control (RRC) reestablishment procedure;
transmitting a first RRC reestablishment request message to a network node via a first relay node;
starting a first timer for RRC reestablishment request in response to transmitting the first RRC reestablishment request message; and
stopping the first timer for RRC reestablishment request in response to a pre-specified condition associated with reception of a notification message being met.

16. A processor for wireless communication, comprising:
at least one controller coupled with at least one memory and configured to cause the processor to:
initiate a first radio resource control (RRC) reestablishment procedure;
transmit a first RRC reestablishment request message to a network node via a first relay node;
start a first timer for RRC reestablishment request in response to transmitting the first RRC reestablishment request message; and
stop the first timer for RRC reestablishment request in response to a pre-specified condition associated with reception of a notification message being met.

17. The processor of claim 16, wherein the notification message indicates at least one of: a handover of the first relay node, a radio link failure (RLF) between the first relay node and the network node, a cell reselection of the first relay node, or an RRC connection failure of the first relay node.

18. The processor of claim 16, wherein the at least one controller is configured to cause the processor to: release configuration information related to a PC5 relay radio link control (RLC) channel, in response to at least one of:
initiating the first RRC reestablishment procedure;
initiating the first RRC reestablishment procedure and the UE not being configured with a conditional reconfiguration configuration associated with a candidate target cell; or
initiating the first RRC reestablishment procedure and the UE not being configured with an indication for indicating that the UE is to perform the conditional reconfiguration configuration if a selected cell is configured with conditional handover (CHO) for the first time after a failure.

19. The processor of claim 16, wherein the at least one controller is further configured to cause the processor to: perform at least one of: a first cell selection operation, a first relay selection operation, or a first relay reselection operation, in response to initiating the first RRC reestablishment procedure.

20. The processor of claim 16, wherein the at least one controller is further configured to cause the processor to: initiate a second RRC reestablishment procedure in response to the pre-specified condition being met or in response to stopping the first timer for RRC reestablishment request; and perform at least one of a second cell selection operation, a second relay selection operation, or a second relay reselection operation after initiating the second RRC reestablishment procedure.
